(19) United States
(12) Patent Application Publication
(10) Pub. No.: US 2023/0123407 A1
(43) Pub. Date: Apr. 20, 2023

(54) SHUT-OFF VALVE FOR A FUEL CELL SYSTEM, AND FUEL CELL SYSTEM

(71) Applicant: Robert Bosch GmbH, Stuttgart (DE)

(72) Inventors: Dirk Schnittger, Ludwigsburg (DE); Benedikt Leibssle, Stuttgart (DE); Friedrich Howey, Ditzingen (DE)

(21) Appl. No.: 17/796,250

(22) PCT Filed: Dec. 28, 2020
(86) PCT No.: PCT/EP2020/087932

§ 371 Date: Jul. 28, 2022

(30) Foreign Application Priority Data
Jan. 31, 2020 (DE) 10 2020 201 178.8

(51) Int. Cl. H01M 8/04082; F16K 31/124; F16K 31/42; H01M 8/04225; H01M 8/04228; H01M 8/04955; H01M 8/04746; H01M 8/04089

(52) U.S. Cl. CPC H01M 8/04201; F16K 31/124; F16K 31/423; H01M 8/04225; H01M 8/04228; H01M 8/04955; H01M 8/04753; H01M 8/04089

(57) ABSTRACT

The invention relates to a shut-off valve (1) for temporarily interrupting the supply of air to a fuel cell stack in a fuel cell system, said shut-off valve comprising a valve piston (3) which can move back and forth in a cylindrical housing bore (2) and is prestressed in the direction of a sealing seat (5) by the spring force of a spring (4), wherein a connection between an air inlet duct (6) and an air outlet duct (7) is established or interrupted depending on the axial position of the valve piston (3). According to the invention, inside the housing bore (2), one end of the valve piston (3) delimits a spring chamber (8) which accommodates the spring (4) and is subjected to ambient pressure, and the other end thereof delimits a control chamber (9) which can be connected to the air inlet duct (7) via a control valve (10). The invention also relates to a fuel cell system comprising a shut-off valve (1) according to the invention.

### BACKGROUND OF THE INVENTION

The invention relates to a shut-off valve for temporarily interrupting the supply of air to a fuel cell stack in a fuel cell system, the shut-off valve comprising a valve piston which can move back and forth in a cylindrical housing bore and is prestressed in the direction of a sealing seat by the spring force of a spring, wherein a connection between an air inlet duct and an air outlet duct is established or interrupted depending on the axial position of the valve piston. The invention further relates to a fuel cell system comprising such a shut-off valve.

In a fuel cell system, valves which interrupt the connection of a fuel cell stack to an air supply are required when the system is at a standstill. As a result, air or oxygen is also to be prevented from passing to the cathode side of a membrane which is arranged between a cathode and an anode. This is because this oxygen diffuses through the membrane from the cathode side to the anode side and thus when the system is started up again it leads to an “air-to-air start” which is damaging for the fuel cell system.

The interruption of the air supply may be brought about by means of so-called shut-off valves. These shut-off valves may act passively or may be controlled actively. The use of a passive valve, for example in the form of a simple check valve, provides the most cost-effective solution. The design of a spring acting in the closing direction, however, proves difficult since the spring force, on the one hand, has to be sufficiently great in order to hold the check valve securely closed and, on the other hand, should not be too great so as not to delay the opening of the valve when the system is started up again. This is because, after an interruption to the air supply, a 100% air flow should be achieved again as rapidly as possible in order to avoid temporary local differences in the fuel cells, which may lead to damage to the system. Moreover, a conventional check valve is able to be used in only one flow direction and is associated with an increased pressure loss. With the active control, the requirement of an additional actuator has proved to be a drawback such that the requirement for installation space increases.

### SUMMARY OF THE INVENTION

It is the object of the present invention to specify a shut-off valve for interrupting the air supply to a fuel cell stack in a fuel cell system which remedies the aforementioned drawbacks of passively and actively controlled shut-off valves. The object is achieved by the shut-off valve of the invention. Advantageous developments of the invention may be derived from the subclaims. Moreover, a fuel cell system comprising such a shut-off valve is specified.

A shut-off valve for temporarily interrupting the air supply to a fuel cell stack in a fuel cell system is proposed. The shut-off valve comprises a valve piston which can move back and forth in a cylindrical housing bore and is prestressed in the direction of a sealing seat by the spring force of a spring. A connection between an air inlet duct and an air outlet duct is established or interrupted depending on the axial position of the valve piston. According to the invention, inside the housing bore, one end of the valve piston delimits a spring chamber which accommodates the spring and is subjected to ambient pressure, and the other end thereof delimits a control chamber which can be connected to the air inlet duct via a control valve.

The proposed shut-off valve is actively controlled by means of the control valve. To this end, the control valve uses the air flow to be switched by the shut-off valve as control energy. Since only a small secondary or control flow has to be switched, rather than the main flow, a relatively small control valve may be used. In particular, in comparison with direct switching, the requirement for additional installation space only increases slightly. Relative to a passively controlled valve, the proposed shut-off valve has the advantage that it may be still actively kept shut even when the air supply system is already started up. This leads to a greater flexibility in the system application.

In a development of the invention it is proposed that the control chamber is able to be relieved of load via the control valve or via a throttle. The load relief via the control valve or the throttle promotes the pressure equalization between the control chamber and spring chamber, which is required for closing the shut-off valve, such that the shut-off valve closes more rapidly. If the control chamber is able to be relieved of load via a throttle, this throttle is preferably configured in an outflow channel or in a connecting channel connecting the control chamber to the spring chamber. The connecting channel may be configured, for example, by an axial bore passing through the valve piston.

The control valve which is provided for active control of the shut-off valve is preferably a 2/2-way valve or a 3/2-way valve. If the control valve is to be used only for switching the control flow in the direction of the control chamber of the shut-off valve, a simple 2/2-way valve is sufficient. If the control chamber is to be relieved of load at the same time via the control valve, the embodiment as a 3/2-way valve is advantageous. The control chamber may be connected to an outflow channel via the further connection of the control valve.

Moreover, it is proposed that the sealing seat has a seat diameter which substantially corresponds to a guide diameter of the valve piston. This is because, when the shut-off valve is closed, it may lead to a negative pressure in the region of the air outlet duct, which exerts an additional closing force on the valve piston and thus negatively affects the opening characteristic of the shut-off valve. If, however, a seat diameter which is approximately equal to the guide diameter is selected, this negative effect may be minimized.

Further preferably, the valve piston has an annular groove on the external peripheral side for connecting the air inlet duct to the air outlet duct. By means of the annular groove, the sealing seat may be positioned on a seat diameter which substantially corresponds to the guide diameter of the valve piston. If a negative pressure is produced in the region of the air outlet duct and thus in the annular groove when the shut-off valve is closed, the opening characteristic of the shut-off valve is substantially unaffected as a result.

According to a preferred embodiment of the invention, the valve piston has an annular collar for forming a sealing surface cooperating with the sealing seat. The annular collar also contributes to the fact that the seat diameter of the sealing seat is able to correspond substantially to the guide diameter of the valve piston. In order to increase the sealing action in the sealing seat, for example, the sealing surface on the annular collar may be conically or spherically shaped. With a spherical shaping, the outer contour may be curved in a concave or convex manner. In all of these cases, it leads to a linear, annular sealing contact when the valve piston is positioned in the sealing seat. The annular collar forming the sealing surface preferably directly adjoins the annular groove of the valve piston.

Moreover, it is proposed that the annular collar on the side remote from the sealing surface forms a stop surface which cooperates with a stroke stop on the housing side. Whilst a first end position of the valve piston is predetermined via the sealing surface configured on the annular collar, in combination with the sealing seat on the housing side, the stop surface which is also configured on the annular collar delimits a second end position in combination with the stroke stop. The valve piston thus moves back and forth between two end positions. In other words, the stroke of the valve piston is delimited. In this manner a rapid closing of the shut-off valve is promoted.

Further preferably, the housing bore accommodating the valve piston has a widening in the form of an annular groove for accommodating the annular collar of the valve piston and/or for forming the stroke stop. The annular groove permits a cylindrical housing bore which—except for in the region of the annular groove—has consistently the same internal diameter for guiding the valve piston. The stroke stop, optionally also configured by the annular groove, preferably cooperates with the stop surface which is configured on the annular collar of the valve piston, if such a stop surface is provided.

Advantageously, the valve piston has at least one annular groove on the external peripheral side, a sealing ring being accommodated therein. A seal of the control chamber and/or of the spring chamber inside the cylindrical housing bore is or are effected via the at least one sealing ring. Preferably, therefore, the valve piston has in each case in the region of its two ends an annular groove with a sealing ring accommodated therein. In this manner, a seal of both the control chamber and of the spring chamber is achieved.

The fuel cell system which is also proposed is characterized in that it comprises a shut-off valve according to the invention for temporarily interrupting the air supply to a fuel cell stack. The shut-off valve ensures that, when the system is shut down, air and thus also oxygen no longer pass to the cathode side of the fuel cell stack.

### BRIEF DESCRIPTION OF THE DRAWINGS

Preferred embodiments of the invention are described in more detail hereinafter with reference to the accompanying drawings, in which:

FIG. 1 shows a schematic longitudinal section through a first shut-off valve according to the invention,

FIG. 2 shows a schematic longitudinal section through a second shut-off valve according to the invention and

FIG. 3 shows a schematic longitudinal section through a third shut-off valve according to the invention.

### DETAILED DESCRIPTION

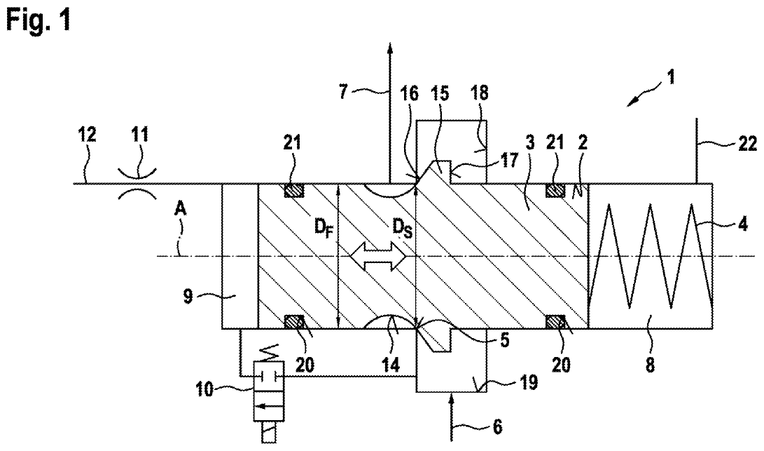

The shut-off valve 1 shown in FIG. 1 serves for temporarily interrupting the air supply to a fuel cell stack in a fuel cell system. To this end, the shut-off valve 1 comprises a valve piston which is accommodated so as to be movable back and forth in a cylindrical housing bore 2, and which inside the housing bore 2 delimits a spring chamber 8 in which a spring 4 is accommodated. Via the spring force of the spring 4, the valve piston 3 is prestressed in the axial direction, i.e. in the direction of a longitudinal axis A, against a sealing seat 5 on the housing side. The spring chamber 8 is connected to the surroundings via a channel 22 such that ambient pressure prevails in the spring chamber 8. On the side remote from the spring chamber 8, inside the housing bore 2 the valve piston 3 delimits a control chamber 9 which is connected via a control valve 10 to an air inlet duct 6, such that the same pressure, i.e. supply pressure, prevails in the control chamber 9 as in the air inlet duct 6. This is higher than ambient pressure and accordingly brings about an opening force which holds the valve piston 3 counter to the spring force of the spring 4 in an open position. In this position, a connection between the air inlet duct 6 and an air outlet duct 7 is established such that air is supplied to the fuel cell stack (not shown) of the fuel cell system.

In FIG. 1 the control valve 10 which is designed as a 2/2-way valve is closed. When the control valve 10 is closed, the pressure in the control chamber 9 corresponds to ambient pressure since the pressure is equalized relative to the surroundings via a throttle 11 which is configured in an outflow channel 12. The valve piston 3 is accordingly in a pressure-equalized state, such that the spring force of the spring 4 pushes the valve piston 3 into the sealing seat 5. In this case, a sealing surface 16 which is configured on an annular collar 15 of the valve piston 3 comes to bear against the sealing seat 5. Since the sealing surface 16 is conically shaped, the sealing contact is linear or annular. In this position, the closed position, the connection between the air inlet duct 6 and the air outlet duct 7 is interrupted. In other words, air is no longer supplied to the fuel cell stack of the fuel cell system.

If the fuel cell system or the air supply is started up again, the control valve 10 opens such that the control chamber 9 is subjected to the supply pressure prevailing in the air inlet duct 6. The pressure in the control chamber 9 rises such that an opening force acts on the valve piston 3, which lifts the valve piston 3 counter to the spring force of the spring 4 out of the sealing seat 5. A connection between the air inlet duct 6 and the air outlet duct 7 is established by means of the opening stroke of the valve piston 3, and namely via an annular groove 14 configured on the external peripheral side in the valve piston 3. The opening stroke of the valve piston 3 is delimited by a stroke stop 18 on the housing side, which is configured by an annular groove 19 widening the housing bore 2 and cooperates with stop surface 17 configured on the valve piston 3.

By means of the annular groove 14 provided on the external peripheral side in the valve piston 3, the seat diameter D_{S} of the sealing seat 5 is selected to be substantially equal to the guide diameter D_{F} of the valve piston 3. If, when the shut-off valve 1 is closed, a negative pressure prevails in the region of the air outlet duct 7 and thus in the annular groove 14, a closing force additionally acting on the valve piston 3 may be minimized thereby. The opening characteristic of the shut-off valve 1 is accordingly not negatively affected or only to an insignificant degree.

Moreover, the valve piston 3 has two further annular grooves 20, in each case a sealing ring 21 being accommodated therein. The control chamber 9 and the spring chamber 8 are sealed relative to the housing bore 2 via the sealing rings 21.

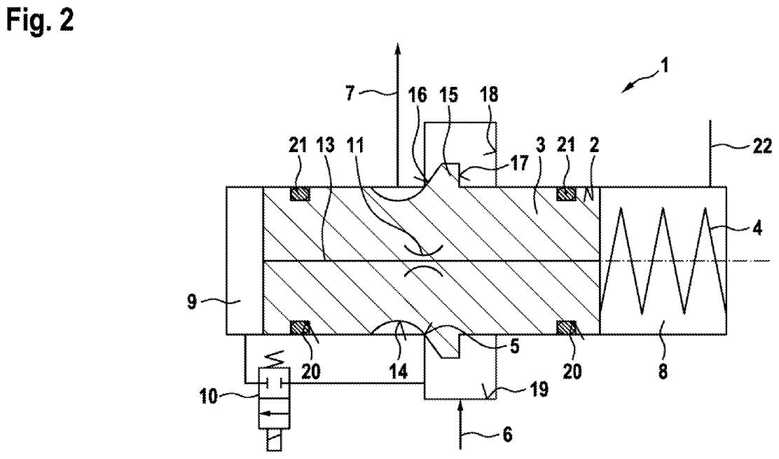

A further shut-off valve 1 according to the invention may be derived from FIG. 2. This shut-off valve differs from the shut-off valve in FIG. 1 in that the throttle 11 is not arranged in an outflow channel 12 but in a connecting channel 13, which passes through the valve piston 3 in the axial direction and thus establishes a connection between the control chamber 9 and the spring chamber 8. The connecting channel 13 accelerates the pressure equalization between the control chamber 9 and the spring chamber 8 required for closing the shut-off valve 1 such that the shut-off valve 1 closes more rapidly.

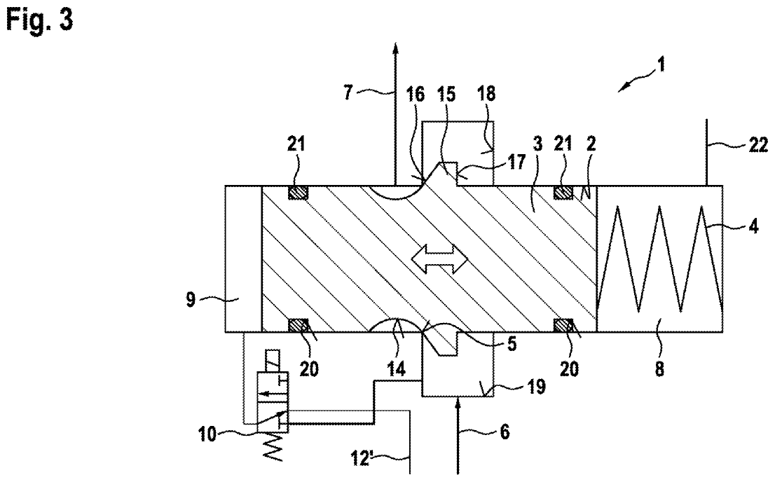

Rather than via a throttle 11, the pressure equalization may also be effected via an outflow channel 12′ which is able to be switched via the control valve 10 to the control chamber 9. This embodiment is shown in FIG. 3 by way of example. To this end, the control valve 10 is designed as a 3/2-way valve.

1. A shut-off valve (1) for temporarily interrupting the supply of air to a fuel cell stack in a fuel cell system, said shut-off valve comprising a valve piston (3) which can move back and forth in a cylindrical housing bore (2) and is prestressed in a direction of a sealing seat (5) by a spring force of a spring (4), wherein a connection between an air inlet duct (6) and an air outlet duct (7) is established or interrupted depending on an axial position of the valve piston (3), characterized in that inside the housing bore (2), one end of the valve piston (3) delimits a spring chamber (8) which accommodates the spring (4) and is subjected to ambient pressure, an other end of the valve piston delimits a control chamber (9), and the shut-off valve also comprises a control valve (10) configured to connect the control chamber (9) to the air inlet duct (7).

2. The shut-off valve (1) as claimed in claim 1, characterized in that the control valve (10) or a throttle (11) is configured to relieve the control chamber (9) of load.

3. The shut-off valve (1) as claimed in claim 1, characterized in that the control valve (10) is a 2/2-way valve or a 3/2-way valve.

4. The shut-off valve (1) as claimed in claim 1, characterized in that the sealing seat (5) has a seat diameter (D_{S}) which substantially corresponds to a guide diameter (D_{F}) of the valve piston (3).

5. The shut-off valve (1) as claimed in claim 1, characterized in that the valve piston (3) has an annular groove (14) on an external peripheral side for connecting the air inlet duct (6) to the air outlet duct (7).

6. The shut-off valve (1) as claimed in claim 1, characterized in that the valve piston (3) has an annular collar (15) for forming a sealing surface (16) cooperating with the sealing seat (5).

7. The shut-off valve (1) as claimed in claim 6, characterized in that the annular collar (15) on a side remote from the sealing surface (16) forms a stop surface (17) which cooperates with a stroke stop (18) on a housing side.

8. The shut-off valve (1) as claimed in claim 7, characterized in that the housing bore (2) has a widening in the form of an annular groove (19) for accommodating the annular collar (15) of the valve piston (3) and/or for forming the stroke stop (18).

9. The shut-off valve (1) as claimed in claim 1, characterized in that the valve piston (3) has at least one annular groove (20) on an external peripheral side, a sealing ring (21) being accommodated therein.

10. A fuel cell system comprising a shut-off valve (1) as claimed in claim 1 for temporarily interrupting the air supply to a fuel cell stack.

11. The shut-off valve (1) as claimed in claim 1, characterized in that the control valve (10) or a throttle (11) is configured to relieve the control chamber (9) of load, wherein the throttle (11) is configured in an outflow channel (12) or in a connecting channel (13) connecting the control chamber (9) to the spring chamber (8).

12. The shut-off valve (1) as claimed in claim 1, characterized in that the valve piston (3) has an annular collar (15) for forming a sealing surface (16) cooperating with the sealing seat (5), wherein the annular collar (15) directly adjoins the annular groove (14).
